(19) United States
(12) Patent Application Publication
(10) Pub. No.: US 2019/0024000 A1
(43) Pub. Date: Jan. 24, 2019

(54) PROCESS FOR CONVERTING MIXED HYDROCARBON STREAMS TO LPG AND BTX

(71) Applicant: SABIC Global Technologies B.V., Bergen op Zoom (NL)

(72) Inventor: Christoph Dittrich, Geleen (NL)

(21) Appl. No.: 16/064,488

(22) PCT Filed: Dec. 12, 2016
(86) PCT No.: PCT/EP2016/080631

§ 371 Date: Jun. 21, 2018

(30) Foreign Application Priority Data
Dec. 22, 2015 (EP) 15201823.0

(51) Int. Cl. C10G 69/10; B01J 8/04

(52) U.S. Cl. CPC C10G 69/10; B01J 8/0457; C10G 2400/30; C10G 2300/70; C10G 2300/1044; C10G 2300/104; C10G 2400/28

(57) ABSTRACT

The present invention relates to a process for converting a feed comprising C5-C12 hydrocarbons to higher BTX, LPG and methane in the presence of hydrogen in n reaction zones operated in series, wherein m reaction zones are not participating in the conversion process and only (n−m) reaction zones are operated under reaction conditions sufficient to convert at least a portion of said a feed comprising C5-C12 hydrocarbons to an effluent having said BTX. An object of the present invention is to provide a process for converting C5-C12 hydrocarbons to LPG, optionally BTX, and methane in the presence of hydrogen wherein coke formation on the catalyst is controlled and the physical movement of particulate catalyst is avoided.

The present invention relates to a process for converting mixed hydrocarbon streams to methane, LPG and BTX. More in detail, the present invention relates to a process for converting a mixed feedstream comprising C5-C12 hydrocarbons to LPG and optionally BTX in the presence of hydrogen with a catalyst having hydrocracking activity in n reaction zones operated in series, wherein m reaction zones are not participating in the conversion process and only (n−m) reaction zones are operated under reaction conditions sufficient to convert at least a portion of said feed comprising C5-C12 hydrocarbons to an effluent having said LPG, methane and optionally BTX.

Aromatic hydrocarbons, particularly benzene, toluene, and xylenes (BTX), are important commodity chemicals in the petrochemical industry. Currently, aromatics are most frequently produced from petroleum-based feedstocks by a variety of processes, including catalytic reforming, catalytic cracking, and steam cracking.

It has been previously described that C5-C12 hydrocarbons can be converted into aromatic hydrocarbons, such as BTX, using a hydrocracking process; see WO 2013/182534 A1. Such hydrocracking processes are characterized in that the catalyst is slowly deactivated by the deposition of coke, which allows the selection of fixed bed reactors with occasional catalyst regeneration.

The hydrocracking process as described in WO 2013/182534 A1 may be associated with coke deposition on the catalyst, leading to catalyst deactivation. Particularly when the catalyst deactivates quickly, it is desired that the catalyst is subjected to frequent or even continuous catalyst regeneration. Moving bed reactors are more suitable than fixed bed reactors for processes with fast catalyst deactivation by coking. The catalyst particles move through the moving bed reactor and are transported to a moving bed regenerator where the coke is removed by combustion or hydrogenolysis. If necessary, other catalyst treatment reactions are carried out in the regenerator, such as active component dispersion and replenishing. Regenerated catalyst is transported back to the moving bed reactor.

However, such moving beds require engineering of an expensive solids transport system and the catalyst is subjected to mechanical forces (grinding and attrition, dust formation) stronger than in fixed beds.

An object of the present invention is to provide a process for converting C5-C12 hydrocarbons to BTX, LPG and methane in the presence of hydrogen wherein coke formation on the catalyst is controlled.

An object of the present invention is to provide a process for converting C5-C12 hydrocarbons to BTX, LPG and methane in the presence of hydrogen wherein the physical movement of particulate catalyst is avoided.

The present invention thus provides a process for converting C5-C12 hydrocarbons to BTX, LPG and methane in the presence of hydrogen in n reaction zones operated in series, wherein m reaction zones are not participating in the conversion process and only (n−m) reaction zones are operated under reaction conditions sufficient to convert at least a portion of said C5-C12 hydrocarbons to an effluent having said BTX, LPG and methane, wherein each reaction zone is initially numbered serially with a designator from 1 to n, the process comprising:

(a) providing a quantity of catalytic material within each reaction zone;

(b) providing to the reaction zone designated as 1 a hydrocarbon feedstock containing C5-C12 hydrocarbons;

(c) cooling at least a portion of the effluent of the said reaction zone designated as 1 to the inlet temperature of the reaction zone designated as 2, and more generally, cooling at least a portion of the effluent of each reaction zone with a designator equal or smaller than (n−m−1) to the inlet temperature of the reaction zone with a designator larger by one than that of the reaction zone from which said effluent originates;

(d) transferring said at least portion of said effluent of the said reaction zone designated as 1 to said reaction zone designated as 2, and more generally, transferring said at least portion of said reaction zone with a designator equal or smaller than (n−m−1) to the reaction zone with a designator larger by one than that of the reaction zone from which said at least portion of said effluent originates;

(e) maintaining said reaction zone designated as 2 at an average temperature higher than or equal as in reaction zone designated as 1, and more generally, maintaining each reaction zone with a designator equal or smaller than (n−m) at an average temperature higher or equal as in the reaction zone with designator smaller by one than that of said reaction zone,

feeding the effluent from the reaction zone with the designator (n−m) to another process unit,

and regenerating the reaction zones with a designator larger than (n−m), followed by

(f) terminating transferring effluent from the reaction zone with the designator (n−m−1) to the reaction zone with the designator (n−m);

(g) starting regenerating said reaction zone with the designator (n−m) containing deactivated catalytic material;

(h) raising the inlet temperature of each reaction zone with a designator equal or smaller than (n−m−1) to the former inlet temperature of the reaction zones with a designator larger by one than that of said reaction zone, respectively;

(i) changing the value of each designator equal or smaller than (n−1) to a number larger by one than its initial value, and changing the value of the designator with a value of n to 1,

(j) repeating steps (b) to (i).

One or more of the above identified objects can be achieved by the present method.

The term “aromatic hydrocarbons” or “aromatics” is very well known in the art. Accordingly, the term “aromatic hydrocarbon” relates to cyclically conjugated hydrocarbon with a stability (due to delocalization) that is significantly greater than that of a hypothetical localized structure (e.g. Kekulé structure). The most common method for determining aromaticity of a given hydrocarbon is the observation of diatropicity in the 1H NMR spectrum, for example the presence of chemical shifts in the range of from 7.2 to 7.3 ppm for benzene ring protons. The term “BTX” as used herein relates to a mixture of benzene, toluene and xylenes.

As used herein, the term “C# hydrocarbons”, or “C#”, wherein “#” is a positive integer, is meant to describe all hydrocarbons having # carbon atoms. Moreover, the term “C#+ hydrocarbons” is meant to describe all hydrocarbon molecules having # or more carbon atoms. Accordingly, the term “C9+ hydrocarbons” is meant to describe a mixture of hydrocarbons having 9 or more carbon atoms. The term “C9+ alkanes” accordingly relates to alkanes having 9 or more carbon atoms.

The term “LPG” as used herein refers to the well-established acronym for the term “liquefied petroleum gas”. LPG generally consists of a blend of C2-C4 alkanes i.e. a mixture of C2, C3, and C4 alkanes.

The hydrocarbon feedstock used in the process of the present invention may be blend of C5-C12 hydrocarbons, preferably having a boiling point in the range of 30-195° C. Preferably, the feedstock mainly comprises C6-C8 hydrocarbons. Suitable feedstocks include, but are not limited to first stage hydro-treated pyrolysis gasoline, straight run naphtha, hydrocracked gasoline, light coker naphtha and coke oven light oil, FCC gasoline, reformate or mixtures thereof. The process of the present invention is also suitable for processing a hydrocarbon feedstock having a relatively high sulphur content, such as pyrolysis gasoline (pygas), straight run naphtha, light coker naphtha and coke oven light oil and mixtures thereof. Furthermore, it is preferred that the non-aromatic species comprised in the hydrocarbon feed are saturated (e.g. by prior hydrogenation) in order to reduce the exotherm within the catalyst bed used in the present process.

The above described sequence is repeated each time the last reactor through which the reactant/products mixture passes, and hence with the highest average temperature and coke level, needs regeneration. In this way, an apparent cocurrent flow pattern between the reactant/products mixture and the catalyst is established without physical movement of the catalyst with the associated problems of solids handling and catalyst attrition. While passing the (n−m) catalyst beds on stream the reactant/products mixture experiences a saw tooth-like but overall constant or increasing profile of the average temperature. The average bed temperature is defined as arithmetic mean of the reactor inlet and outlet temperature. It should be noted that the above identified parameters “n reaction zones operated in series”, “m reaction zones not participating in the conversion process” and “(n−m) reaction zones operated under reaction conditions” leave room for an embodiment wherein less than (n−m) reaction zones are under regeneration conditions, or an embodiment wherein different types of regeneration methods are applied. The present method is preferably carried out when the n reaction zones are of equal size.

In addition a conversion of certain components of the mixed C5-C12 hydrocarbon feed stream can be achieved with an increasing temperature profile because reaction rates increase with increasing temperature. If the reaction zones are operated adiabatically, the heat of reaction will need to be removed by decreasing the temperature of each stream being transferred from each reaction zone with a designator equal to or smaller than (n−m−1) to a reaction zone with a designator larger by one than that of said reaction zone. The total heat of reaction can be evenly distributed over (n−m) reaction zones of equal size with an increasing profile of the average temperature.

The present inventor found that the process of the present invention can also be used for establishing an apparent countercurrent flow pattern between the reactant/product mixture and the catalyst. According to such an apparent cocurrent flow pattern operation the present method comprises the same steps (a) to (e) as discussed before, followed by

(f) terminating transferring effluent from the reaction zone designated as 1 to the reaction zone designated as 2;

(g) starting regenerating the reaction zone designated as 1 containing deactivated catalytic material;

(h) decreasing the inlet temperature of each reaction zone with a designator larger than 1 and equal or smaller than (n−m) to the former inlet temperature of the reaction zones with a designator smaller by one than that of said reaction zone, respectively;

(i) changing the value of each designator equal and larger than 2 to a number smaller by one than its initial value, and changing the value of the designator with value 1 to n,

(j) repeating steps (b) to (i).

In such an apparent countercurrent flow pattern mode, the catalyst in those of the first (n−m) reactions zones which are designated by a smaller value is more deactivated and hence less active. It is therefore easier to evenly distribute the total heat of reaction over (n−m) adiabatic reaction zones of equal size, even without an increasing profile of average bed temperatures in reaction zones (n−m).

According to a preferred embodiment of the present invention the reaction zones are adiabatic catalytic fixed bed reaction zones. Adiabatic catalytic fixed bed reaction zones can be axial flow fixed bed reactors or radial flow fixed bed reactors.

The process of the present invention involves hydrocracking of C5-C12 hydrocarbons, which comprises contacting the C5-C12 hydrocarbons with a hydrocracking catalyst under hydrocracking conditions. The process conditions useful for hydrocracking, also described herein as “hydrocracking conditions”, can be easily determined by the person skilled in the art; see e.g. Alfke et al. (2007) Oil Refining, Ullmann's Encyclopedia of Industrial Chemistry.

The term “hydrocracking” is used herein in its generally accepted sense and thus may be defined as a process to convert aliphatic hydrocarbons and substituted aromatics to smaller saturated aliphatic hydrocarbon molecules and BTX. There are many hydrocracking technologies described in the prior art using C5-C12 hydrocarbons as raw material; see e.g. WO 2013/182534 A1 and WO 2015/000840 A1.

Accordingly, the hydrocracking step comprised in the process of the present invention comprises contacting the C5-C12 hydrocarbon feedstock with a hydrocracking catalyst at hydrocracking process conditions. The products of this process are saturated hydrocarbons, naphthenic (cycloalkane) hydrocarbons and, depending on the reaction conditions such as temperature, pressure and space velocity and catalyst activity, aromatic hydrocarbons including BTX. The process conditions used for hydrocracking generally includes a process temperature of 200-600° C., elevated pressures of 0.2-20 MPa, space velocities between 0.1-10 h⁻¹. Hydrocracking reactions proceed through a bifunctional mechanism which requires an acid function, which provides for the cracking and isomerization and which provides breaking and/or rearrangement of the carbon-carbon bonds comprised in the hydrocarbon compounds comprised in the feed, and a hydrogenation function. Many catalysts used for the hydrocracking process are formed by combining various transition metals, or metal sulfides with the solid support such as alumina, silica, alumina-silica, magnesia and zeolites.

The hydrocracking process step comprised in the process of the present invention may be adapted to the composition of the feedstock and the desired process products. The composition of naphtha feedstock, for instance, commonly is very different from a mixed C5-12 hydrocarbon feedstock that is derived from a refinery unit or a steam cracker, especially in terms of the aromatics content. In the context of the present invention, a distinction is made between a hydrocracking process step that is optimized towards the conservation of aromatic hydrocarbons such as BTX comprised in the feed, and a hydrocracking process step that is optimized towards improving the LPG yield at the expense of the BTX yield.

As used herein, the term “gasoline hydrocracking” or “GHC” refers to a hydrocracking process step for that is specifically suitable for converting a complex hydrocarbon feed that is relatively rich in aromatic hydrocarbon compounds—such as refinery unit-derived light-distillate including, but not limited to, reformer gasoline, FCC gasoline and pyrolysis gasoline (pygas)—to LPG and BTX, wherein said process is optimized to keep one aromatic ring intact of the aromatics comprised in the GHC feedstream, but to remove most of the side-chains from said aromatic ring.

Accordingly, the main product produced by gasoline hydrocracking is BTX and the process can be optimized to provide chemicals-grade BTX. Preferably, the hydrocarbon feed that is subject to gasoline hydrocracking comprises refinery unit-derived light-distillate. More preferably, the hydrocarbon feed that is subjected to gasoline hydrocracking preferably does not comprise more than 1 wt-% of hydrocarbons having more than one aromatic ring. Preferably, the gasoline hydrocracking conditions include a temperature of 300-580° C., more preferably of 450-580° C. and even more preferably of 470-550° C. Lower temperatures must be avoided since hydrogenation of the aromatic ring becomes favourable. However, in case the catalyst comprises a further element that reduces the hydrogenation activity of the catalyst, such as tin, lead or bismuth, lower temperatures may be selected for gasoline hydrocracking; see e.g. WO 02/44306 A1 and WO 2007/055488. In case the reaction temperature is too high, the yield of LPG's (especially propane and butanes) declines and the yield of methane rises. As the catalyst activity may decline over the lifetime of the catalyst, it is advantageous to increase the reactor temperature gradually over the life time of the catalyst to maintain the hydrocracking conversion rate. This means that the optimum temperature at the start of an operating cycle preferably is at the lower end of the hydrocracking temperature range. The optimum reactor temperature will rise as the catalyst deactivates so that at the end of a cycle (shortly before the catalyst is replaced or regenerated) the temperature preferably is selected at the higher end of the hydrocracking temperature range.

Preferably, the gasoline hydrocracking of the hydrocarbon feedstock containing C5-C12 hydrocarbons is performed at a pressure of 0.3-5 MPa gauge, more preferably at a pressure of 0.6-3 MPa gauge, particularly preferably at a pressure of 1-2 MPa gauge and most preferably at a pressure of 1.2-1.6 MPa gauge. By increasing reactor pressure, conversion of C5+ non-aromatics can be increased, but this also increases the yield of methane and the hydrogenation of aromatic rings to cyclohexane species which can be cracked to LPG species. This results in a reduction in aromatic yield as the pressure is increased and, as some cyclohexane and its isomer methylcyclopentane, are not fully hydrocracked, there is an optimum in the purity of the resultant benzene at a pressure of 1.2-1.6 MPa.

Preferably, gasoline hydrocracking of a hydrocarbon feedstock containing C5-C12 hydrocarbons is performed at a Weight Hourly Space Velocity (WHSV) of 0.1-10 h⁻¹, more preferably at a Weight Hourly Space Velocity of 0.2-6 h⁻¹ and most preferably at a Weight Hourly Space Velocity of 0.4-2 h⁻¹. When the space velocity is too high, not all BTX co-boiling paraffin components are hydrocracked, so it will not be possible to achieve BTX specification by simple distillation of the reactor product. At too low space velocity the yield of methane rises at the expense of propane and butane. By selecting the optimal Weight Hourly Space Velocity, it was surprisingly found that sufficiently complete reaction of the benzene co-boilers is achieved to produce on spec BTX without the need for a liquid recycle.

Accordingly, preferred gasoline hydrocracking conditions thus include a temperature of 450-580° C., a pressure of 0.3-5 MPa gauge and a Weight Hourly Space Velocity of 0.1-10 h⁻¹. More preferred gasoline hydrocracking conditions include a temperature of 470-550° C., a pressure of 0.6-3 MPa gauge and a Weight Hourly Space Velocity of 0.2-6 h⁻¹. Particularly preferred gasoline hydrocracking conditions include a temperature of 470-550° C., a pressure of 1-2 MPa gauge and a Weight Hourly Space Velocity of 0.4-2 h⁻¹.

As used herein, the term “feed hydrocracking” or “FHC” refers to a hydrocracking process step for that is specifically suitable for converting a complex hydrocarbon feed that is relatively rich in naphthenic and paraffinic hydrocarbon compounds—such as straight run cuts including, but not limited to, naphtha- to LPG and alkanes. Preferably, the hydrocarbon feed that is subject to feed hydrocracking comprises naphtha and/or the C5-C12 fraction produced by a refinery process. Accordingly, the main product produced by feed hydrocracking is LPG. The FHC process may be optimized to keep one aromatic ring intact of the aromatics comprised in the FHC feedstream, but to remove most of the side-chains from said aromatic ring. In such a case, the process conditions to be employed for FHC are comparable to the process conditions to be used in the GHC process as described herein above. Preferably, the FHC process conditions comprise a lower process temperature than the GHC process to reduce the methane make. Accordingly, the FHC process conditions comprise a temperature of 300-450° C., a pressure of 300-5000 kPa gauge and a Weight Hourly Space Velocity of 0.1-10 h⁻¹. Even more preferred FHC conditions optimized to the ring-opening of aromatic hydrocarbons include a temperature of 300-400° C., a pressure of 600-3000 kPa gauge and a Weight Hourly Space Velocity of 0.2-2 h⁻¹. Alternatively, the FHC process can be optimized to open the aromatic ring of the aromatic hydrocarbons comprised in the FHC feedstream. This can be achieved by modifying the GHC process as described herein by increasing the hydrogenation activity of the catalyst, optionally in combination with selecting a lower process temperature, optionally in combination with a reduced space velocity. In such a case, preferred feed hydrocracking conditions thus include a temperature of 300-550° C., a pressure of 300-5000 kPa gauge and a Weight Hourly Space Velocity of 0.1-10 h-1. More preferred feed hydrocracking conditions include a temperature of 300-450° C., a pressure of 300-5000 kPa gauge and a Weight Hourly Space Velocity of 0.1-10 h⁻¹. Even more preferred FHC conditions optimized to the ring-opening of aromatic hydrocarbons include a temperature of 300-400° C., a pressure of 600-3000 kPa gauge and a Weight Hourly Space Velocity of 0.2-2 h⁻¹. The process of the present invention is particularly suitable in combination with a FHC process since such a FHC process generally is more prone to coke deposition on the catalyst.

The number ratio of reactors on stream (n−m) and in regeneration (m) is determined depending on the ratio of durations of coke build-up during reaction, and purging, cooling down and regeneration. If these durations change, e.g. because a better catalyst is implemented or the operating conditions are changed, the number of reactors on stream (n−m) and in regeneration (m) can be adjusted accordingly without any hardware modification. A new sequence for routing the inter-reactor streams is sufficient. In a preferred embodiment the total number of reaction zones, n, is at least 4, preferably at least 6, wherein said total number of reaction zones not participating in the conversion process is at most 4, preferably at most 2, respectively. However, the present invention is not limited to a specific number of reaction zones or to a specific number of reaction zones not participating in the conversion process.

According to a preferred embodiment step (f) further comprises monitoring the temperature rise along said bed of catalytic material and terminating transferring effluent when said temperature rise falls below a threshold value, or the outlet temperature falls below a certain threshold value.

According to a preferred embodiment the inlet temperatures of reactor zones 1 to (n−m) are adjusted slightly during the period between two cycle switching events in order to compensate for activity loss of catalyst inside the reaction zones 1 to (n−m) during said period. As a result, the temperature rise along the catalyst beds in reaction zones 1 to (n−m) remains constant or deviates not more than 10% from a constant value.

According to a preferred embodiment step (g) further comprises cooling down (n−m)th reaction zone bed of catalytic material in apparent cocurrent flow pattern operation with a purge gas and passing a regeneration gas through the thus cooled bed of catalytic material. It analogously comprises cooling down first reaction zone bed of catalytic material in apparent countercurrent flow pattern operation. The purge gas can be any gas that does not or to not much extend react with the catalyst and reactant and product, for example steam, nitrogen or noble gases. Preferably, nitrogen is used as purge gas.

Coke formation increases with higher temperatures and limits the reaction rate. It is secured with the increasing temperature profile and simulated cocurrent flow that the catalyst is hardly deactivated by coke at low temperature and most deactivated at high temperature where reaction rates are high anyway. The hottest and most deactivated catalyst is the first to be regenerated in the next cycle. Hence, the catalyst coking level increases together with increasing temperature in flow direction of the reactant/product mixture. The catalyst is regenerated by coke removal via combustion. If the catalyst is not heat sensitive, or does not form volatile components with oxygen or steam, (enriched) air, or mixtures of steam and (enriched) air can be used to convert coke into carbon oxides. If the catalyst forms volatile components with oxygen, hydrogen-rich gas can be used to convert coke into methane or other hydrocarbons by hydrogenolysis.

Catalyst regeneration by both, combustion or hydrogenolysis, is exothermic and heats up the adiabatic fixed beds. It therefore can be necessary to cool down the catalyst bed prior to regeneration such that it reaches the desired temperature level after regeneration and prior to the next reaction cycle. The reactor to be cooled down can serve as a feed preheater to the first reactor in operation simply by switching off the preheater of the reactor to be cooled down when the end of a cycle approaches.

The regeneration gas is preferably chosen from the group of steam, air, oxygen and hydrogen, or suitable mixtures thereof.

In a preferred embodiment the regeneration gas comprises at least two different components, wherein the different components are dosed together or the different components are dosed in a cycle.

It is often beneficial to regenerate the catalyst by burning off coke at not too high temperature in order to avoid that the large combustion exotherm irreversibly damages the catalyst.

In a preferred embodiment regeneration by coke combustion with oxygen-containing regeneration gas is carried out at a temperature lower than the minimum temperature at which the reaction in reaction zone 1 to (n−m) takes place.

The underlying principle of the present invention can also be applied to other exothermic hydrocarbon conversions accompanied by coke formation, such as conversion of methanol into olefins or gasoline.

The present invention will now be discussed by way of an example.

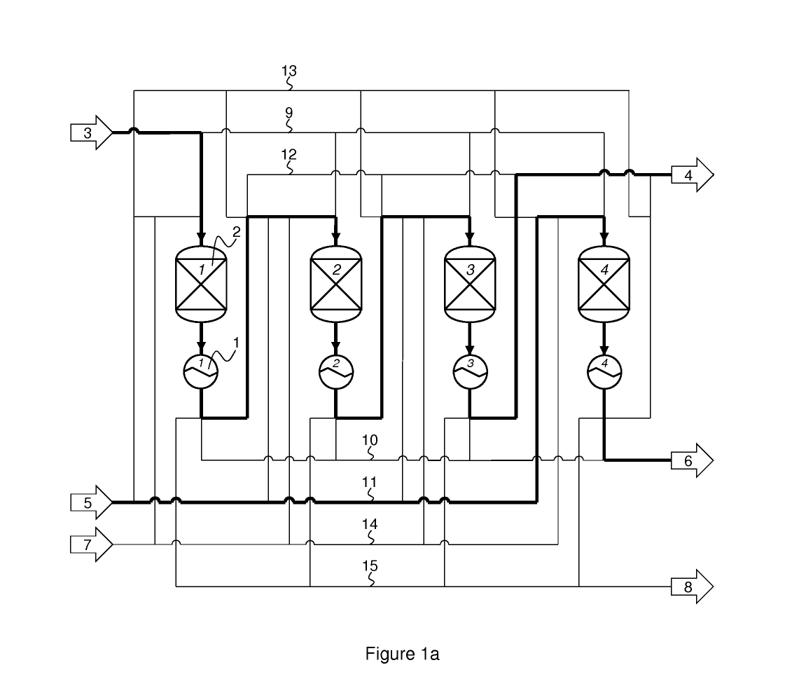

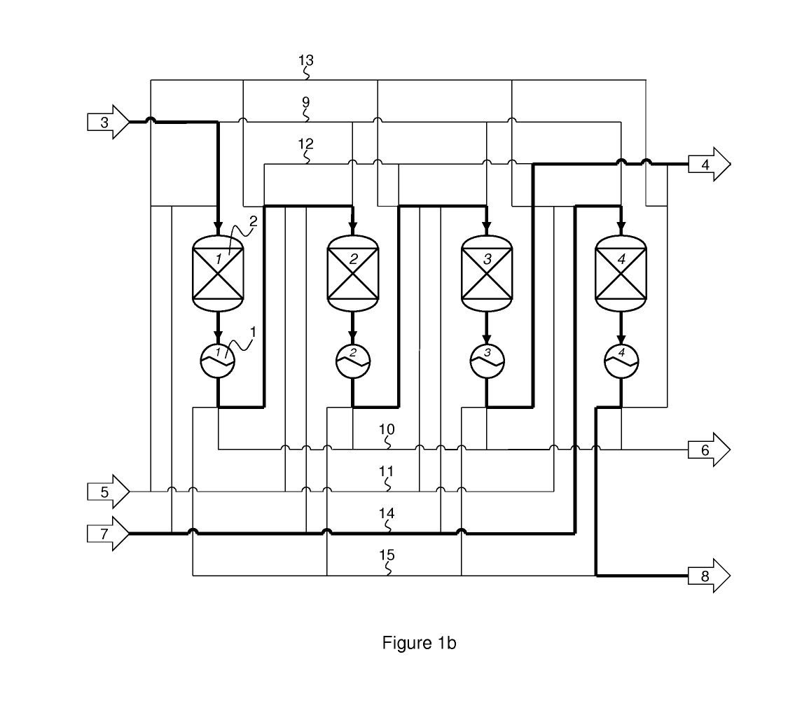

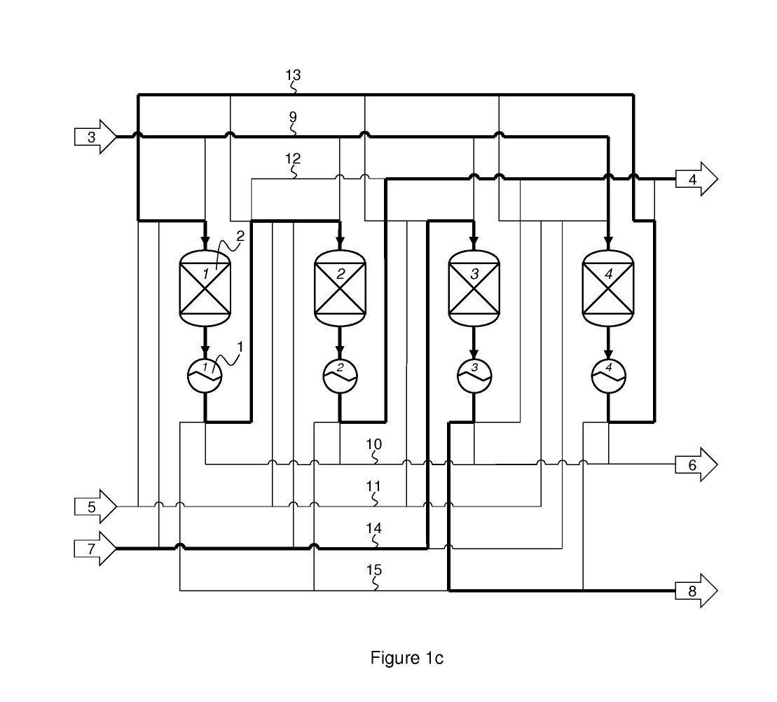

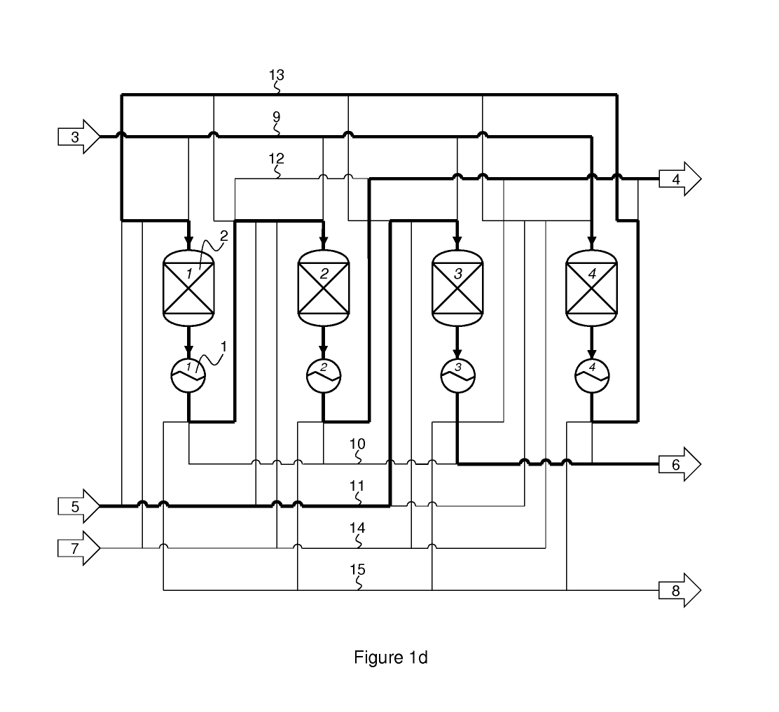

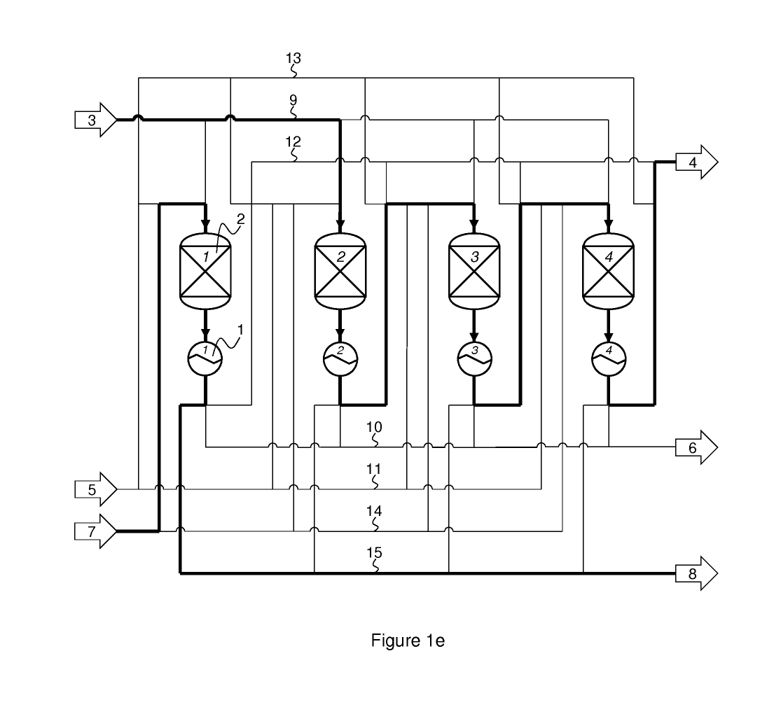

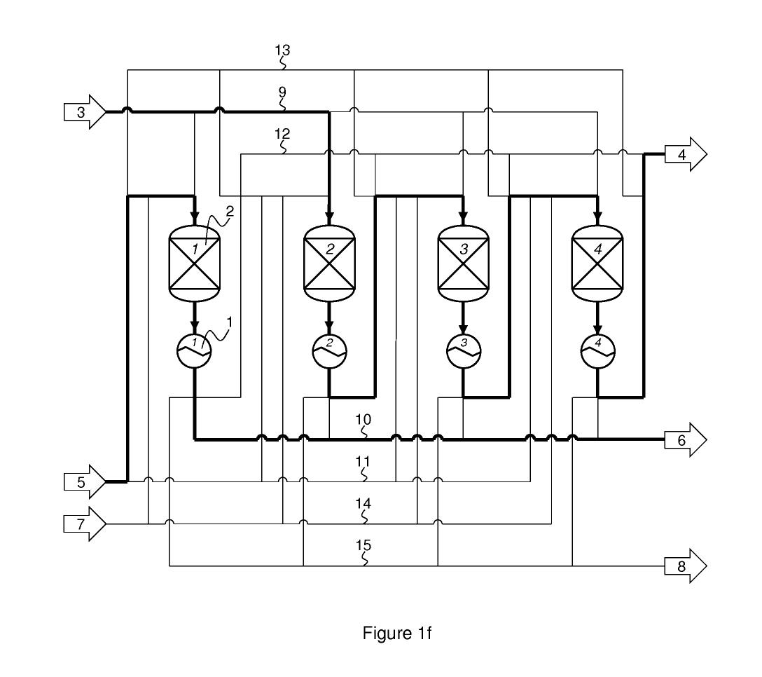

FIG. 1a shows an embodiment of a process for converting C5-C12 hydrocarbons to BTX, LPG and methane.

FIG. 1b shows another phase of the same process for converting C5-C12 hydrocarbons to BTX, LPG and methane.

FIG. 1c shows another phase of the same process for converting C5-C12 hydrocarbons to BTX, LPG and methane with simulated cocurrent flow of reactants, products and catalyst.

FIG. 1d shows another phase of the same process for converting C5-C12 hydrocarbons to BTX, LPG and methane with simulated cocurrent flow of reactants, products and catalyst.

FIG. 1e shows another phase of the process for converting C5-C12 hydrocarbons to BTX, LPG and methane with simulated countercurrent flow of reactants, products and catalyst.

FIG. 1f shows another phase of the process for converting C5-C12 hydrocarbons to BTX, LPG and methane with simulated countercurrent flow of reactants, products and catalyst.

No valves are shown in FIGS. 1a-1f for better readability. Pipelines with fluid flow are marked by bold line and pipelines without fluid flow are marked by thin lines.

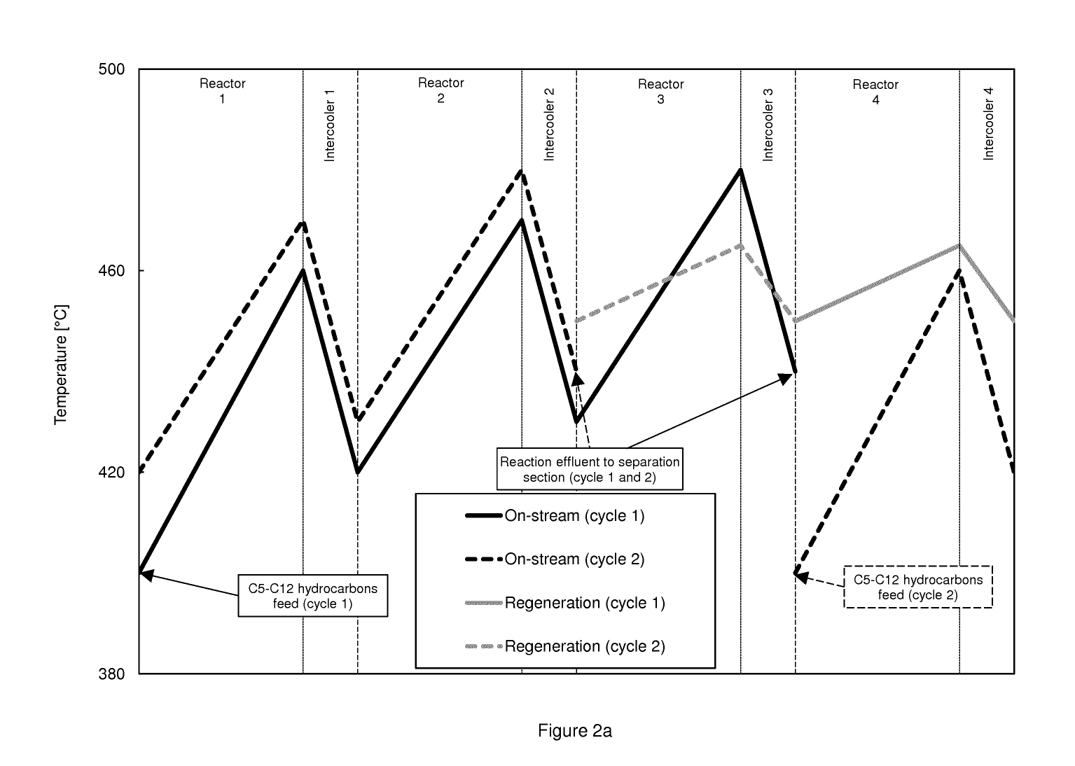

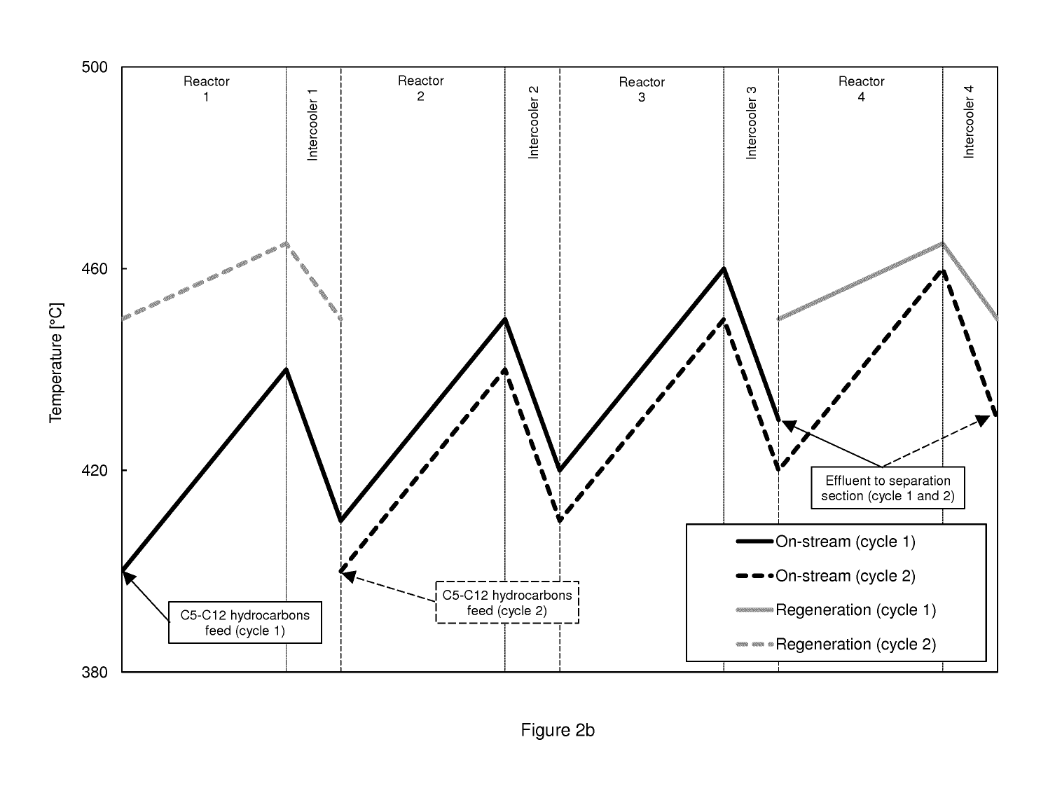

FIG. 2a illustrates the temperature profile during the first two cycles with simulated cocurrent flow of reactants, products and catalyst shown in FIGS. 1a-1d.

FIG. 2b illustrates the temperature profile during the first two cycles with simulated countercurrent flow of reactants, products and catalyst shown in FIGS. 1a-b, and 1e-1f.

Mixed C5-C12 hydrocarbon feedstock and hydrogen are fed to the first of a series of n adiabatic catalytic fixed bed reactors. The feed is brought to a preset temperature in a preheater and sent to the first reactor. Each reactor contains particulate catalyst, e.g. a catalyst comprising one or more transition metals or metal sulfides and a solid catalyst support. m reactors are being regenerated in order to remove coke from the catalyst while n−m reactors are on stream, which means convert C5-C12 hydrocarbons into BTX, LPG and methane.

The mixture of hydrogen, reactant and nascent products passes through the first adiabatic reactor where it heats up due to the exothermic nature of the reaction.

Hence, an increasing temperature profile along the flow direction is established inside the catalytic fixed bed of the first reactor. After leaving the first reactor, the effluent is cooled down again and enters the second reactor. More C5-C12 hydrocarbons are converted into BTX, LPG and methane in the second reactor where the reactant/product mixture heats up and a rising temperature profile is again established. The outlet temperature of the second reactor is higher than the outlet temperature of the first reactor. The sequence of cooling the hydrogen/reactant/product mixture, the conversion of the cooled mixture inside each reactor accompanied by temperature increase, and the converted mixture leaving each reactor at a higher temperature than the outlet temperature of the previous reactor is repeated according to the total number (n−m) of reactors on stream.

The detailed discussion of the FIGS. 1a-1f relates to the specific embodiment of the present invention in which the overall temperature profile increases.

### EXAMPLE 1

A first example is given in FIG. 1a with n=4 reactors of which m=1 reactor is regenerated and which are operated to simulate a cocurrent flow pattern of reactant-feed mixture and solid catalyst. The effluent of the last (n−m)th reactor on stream is quenched and fed to the product separation section of the process. As a result of the increasing profile of the inlet temperatures of each of the (n−m) reactors on stream the catalytic fixed bed of the (n−m)th reactor has the highest average temperature (FIG. 2a). This implies that the rate of coke formation, which is an undesired side reaction, is highest and therefore the catalyst deactivates most quickly in the (n−m)th reactor.

When a preset minimum conversion is reached indicated by a minimum temperature rise along the catalytic bed of the (n−m)th reactor as result of catalyst deactivation, the (n−m)th reactor will be taken off stream and regenerated. The nth reactor was regenerated until now and is purged from regeneration gas, e.g. preheated diluted air (FIG. 1b). The catalytic bed of the (n−m)th reactor is first cooled down by a purge gas, e.g. nitrogen (FIG. 1c), and then the catalyst is regenerated by converting coke with a regeneration gas. At the same time, all inlet temperature set points of the first to (n−m−1)th reactor are raised to the values of the second to (n−m)th reactor before the (n−m)th reactor was taken off stream for regeneration. Then the feed stream is not fed to the first reactor anymore but to the nth reactor (FIG. 1c). The inlet temperature set point of the nth reactor is now the same as for the first reactor before the (n−m)th reactor was taken off stream for regeneration. According to FIG. 1d the effluent of the nth reactor is now routed to the first reactor (n=4 and m=1).

The (n−m−1)th reactor has the highest average temperature now (FIG. 2a) and will be the next one to be regenerated. Once the temperature rise inside the (n−m−1)th reaches a preset minimum value the same switching sequence is triggered like described above. After the new switching event, the feed will be routed to the (n−2)th reactor, the average temperature level in the (n−m−2)th reactor will be the highest and the effluent of the (n−m−2)th reactor is fed to the product separation section (n=4 and m=1).

The process as discussed above has been disclosed in Table 1 and FIG. 2a.

TABLE 1
Schematic overview of status of reaction zones in the process according
to the invention (example 1, cocurrent flow of hydrogen reactant,
products and catalyst)

Reaction zone (number)

| | | 1 | 2 | 3 | 4 |
|---|---|---|---|---|---|
| Cycle | 1 | R | R | R | X |
| | 2 | R | R | X | R |
| | 3 | R | X | R | R |
| | 4 | X | R | R | R |
| | 5 | R | X | X | X |

From Table 1 one can deduce that in the first cycle only reaction zones 1-3 are participating in the conversion process whereas reaction zone 4 is not participating in the conversion process. The sequence in the first cycle is thus 1-2-3 (on stream) and 4 (off stream). In the second cycle reaction zone 4 is taken on stream and the “first” reaction zone will now be reaction zone 4. The effluent from reaction zone 4 is fed to the inlet of first reaction zone, now being reaction zone 1. The sequence in the second cycle is thus 4-1-2 (on stream) and 3 (off stream), wherein the highest temperature is in reaction zone 2. The sequence in the third cycle is thus 3-4-1 (on stream) and 2 (off stream), wherein the highest temperature is in reaction zone 1. This table 1 shows a number of five cycles wherein the situation of cycle 1 is similar to cycle 5. As mentioned before, the present invention is not restricted to any specific number of reaction zones.

In the FIGS. 1a-1g the reference numbers used refer to the following:
1 Intercooler 1 to n (4)
2 Reaction zone 1 to n (4)
3 Hydrogen and C5-C12 hydrocarbon feed
4 Product mixture
5 Oxygen-containing regeneration gas feed
6 Regeneration gas effluent
7 Purge gas feed
8 Purge gas effluent

### EXAMPLE 2

A second example is given in FIGS. 1a-1b and-1e-1f with n=4 reactors of which m=1 reactor is regenerated with oxygen-containing gas, and which are operated to simulate a countercurrent flow pattern of reactant-feed mixture and solid catalyst.

The effluent of the last (third) reactor on stream is quenched and fed to the product separation section of the process. The catalyst in the first reactor has accumulated more coke and is more deactivated than that in the second and third reactor because it has been on stream for longer.

When a preset minimum conversion is reached indicated by a minimum temperature rise along the catalytic bed of the first reactor as result of catalyst deactivation, the first reactor will be taken off stream and regenerated. For this, the catalyst is regenerated by combusting coke with an oxygen-containing regeneration gas. At the same time, the inlet temperature set point of the second reactor is adjusted to the value of the first reactor before it was taken off stream for regeneration. The feed stream is not fed to the first reactor anymore but to the second reactor (FIG. 1f). The inlet temperature set point of the second reactor is now the same as for the first reactor before it was taken off stream for regeneration. According to FIG. 1f the effluent of the second reactor is now routed to the third reactor.

The catalyst bed of the second reactor has been on stream for the longest time now and will be the next one to be regenerated. Once the temperature drop inside the second reactor reaches a preset minimum value the same switching sequence is triggered like described above.

FIG. 1b shows how the fourth reactor is purged from oxygen-containing regeneration gas before it is coming on stream in FIG. 1e, and FIG. 1e shows how the first reactor taken off-stream is purged from hydrocarbons before taken into regeneration in FIG. 1f.

Table 2 gives an overview of a complete repetition of switching events (cycles #1 to 4),

TABLE 2
Schematic overview of status of reaction zones in the process according
to the invention (example 1, countercurrent flow of reactant,
products and catalyst)

Reaction zone (number)

| | | 1 | 2 | 3 | 4 |
|---|---|---|---|---|---|
| Cycle | 1 | R | R | R | X |
| | 2 | X | R | R | R |
| | 3 | R | X | R | R |
| | 4 | R | R | X | R |
| | 5 | R | R | R | X |

1. A process for converting a mixed C5-C12 hydrocarbons stream to BTX, LPG and methane in the presence of hydrogen in n reaction zones operated in series, wherein m reaction zones are not participating in the conversion process and only (n−m) reaction zones are operated under reaction conditions sufficient to convert at least a portion of said C5-C12 hydrocarbon stream to an effluent having said BTX, wherein each reaction zone is initially numbered serially with a designator from 1 to n, the process comprising:
(a) providing a quantity of catalytic material within each reaction zone;
(b) providing to the reaction zone designated as 1 a hydrocarbon feedstock containing C5-C12 hydrocarbons and hydrogen;
(c) cooling at least a portion of the effluent of the said reaction zone designated as 1 to the inlet temperature of the reaction zone designated as 2, and more generally, cooling at least a portion of the effluent of each reaction zone with a designator equal or smaller than (n−m−1) to the inlet temperature of the reaction zone with a designator larger by one than that of the reaction zone from which said effluent originates;
(d) transferring said at least portion of said effluent of the said reaction zone designated as 1 to said reaction zone designated as 2, and more generally, transferring said at least portion of said reaction zone with a designator equal or smaller than (n−m−1) to the reaction zone with a designator larger by one than that of the reaction zone from which said at least portion of said effluent originates;
(e) maintaining said reaction zone designated as 2 at an average temperature higher than or equal as in reaction zone designated as 1, and more generally, maintaining each reaction zone with a designator equal or smaller than (n−m) at an average temperature higher or equal as in the reaction zone with designator smaller by one than that of said reaction zone,
feeding the effluent from the reaction zone with the designator (n−m) to another process unit,
and regenerating the reaction zones with a designator larger than (n−m), followed by
(f) terminating transferring effluent from the reaction zone with the designator (n−m−1) to the reaction zone with the designator (n−m);
(g) starting regenerating said reaction zone with the designator (n−m) containing deactivated catalytic material;
(h) raising the inlet temperature of each reaction zone with a designator equal or smaller than (n−m−1) to the former inlet temperature of the reaction zones with a designator larger by one than that of said reaction zone, respectively;
(i) changing the value of each designator equal or smaller than (n−1) to a number larger by one than its initial value, and changing the value of the designator with a value of n to 1,
(j) repeating steps (b) to (i).

2. A process for converting a mixed C5-C12 hydrocarbons stream to BTX, LPG and methane in presence of hydrogen in n reaction zones operated in series, wherein m reaction zones are not participating in the conversion process and only (n−m) reaction zones are operated under reaction conditions sufficient to convert at least a portion of said C5-C12 hydrocarbon stream to an effluent having said BTX, wherein each reaction zone is initially numbered serially with a designator from 1 to n, the process comprising:
(a) providing a quantity of catalytic material within each reaction zone;
(b) providing to the reaction zone designated as 1 a hydrocarbon feedstock containing C5-C12 hydrocarbons and hydrogen;
(c) cooling at least a portion of the effluent of the said reaction zone designated as 1 to the inlet temperature of the reaction zone designated as 2, and more generally, cooling at least a portion of the effluent of each reaction zone with a designator equal or smaller than (n−m−1) to the inlet temperature of the reaction zone with a designator larger by one than that of the reaction zone from which said effluent originates;
(d) transferring said at least portion of said effluent of the said reaction zone designated as 1 to said reaction zone designated as 2, and more generally, transferring said at least portion of said reaction zone with a designator equal or smaller than (n−m−1) to the reaction zone with a designator larger by one than that of the reaction zone from which said at least portion of said effluent originates;
(e) maintaining said reaction zone designated as 2 at an average temperature higher than or equal as in reaction zone designated as 1, and more generally, maintaining each reaction zone with a designator equal or smaller than (n−m) at an average temperature higher or equal as in the reaction zone with designator smaller by one than that of said reaction zone,
feeding the effluent from the reaction zone with the designator (n−m) to another process unit,
and regenerating the reaction zones with a designator larger than (n−m), followed by
(f) terminating transferring effluent from the reaction zone designated as 1 to the reaction zone designated as 2;
(g) starting regenerating the reaction zone designated as 1 containing deactivated catalytic material;
(h) decreasing the inlet temperature of each reaction zone with a designator larger than 1 and equal or smaller than (n−m) to the former inlet temperature of the reaction zones with a designator smaller by one than that of said reaction zone, respectively;
(i) changing the value of each designator equal and larger than 2 to a number smaller by one than its initial value, and changing the value of the designator with value 1 to n,
(j) repeating steps (b) to (i).

3. The process according to claim 1, wherein said reaction zones are adiabatic catalytic fixed bed reaction zones.

4. The process according to claim 3, wherein said adiabatic catalytic fixed bed reaction zones are adiabatic radial flow fixed bed reactors.

5. The process according to claim 1, wherein said catalytic material comprises one or more transition metals or metal sulfides and a solid catalyst support.

6. The process according to claim 1, wherein said total number of reaction zones, n, is at least 4, wherein said total number of reaction zones not participating in the conversion process is at most 4.

7. The process according to any one or more of claim 1, wherein step (f) further comprises monitoring the temperature rise along said bed of catalytic material and terminating transferring effluent when said temperature rise comes below a threshold value.

8. The process according to any one or more of claim 1, wherein the inlet temperature of each reaction zone not in regeneration is continuously adjusted in small steps such that the temperature rise along the catalyst bed in said reaction zone deviates not more than 10% from a constant value.

9. The process according to any one of the claim 1, wherein in said step (g) of regenerating a regeneration gas is chosen from the group of steam, air, oxygen and hydrogen, or suitable mixtures thereof.

10. The process according to claim 9, wherein said regeneration gas comprises at least two different components, said different components are dosed together.

11. The process according to claim 9, wherein said regeneration gas comprises at least two different components, said different components are dosed in a sequence.

12. The process according to claim 1, wherein the exothermic heat originating from regenerating said bed of catalytic material is used for preheating of fresh feed to the first reactor on stream.

13. The process according to claim 1, wherein the mixed C5-C12 hydrocarbons is selected from the group consisting of pyrolysis gasoline, straight run naphtha, hydrocracked gasoline, light coker naphtha, coke oven light oil, FCC gasoline and reformate or a mixture thereof.

14. The process according to claim 2, wherein said reaction zones are adiabatic catalytic fixed bed reaction zones.

15. The process according to claim 2, wherein said catalytic material comprises one or more transition metals or metal sulfides and a solid catalyst support.

16. The process according to claim 2, wherein said total number of reaction zones, n, is at least 4, wherein said total number of reaction zones not participating in the conversion process is at most 4.

17. The process according to claim 2, wherein step (f) further comprises monitoring the temperature rise along said bed of catalytic material and terminating transferring effluent when said temperature rise comes below a threshold value.

18. The process according to claim 2, wherein the inlet temperature of each reaction zone not in regeneration is continuously adjusted in small steps such that the temperature rise along the catalyst bed in said reaction zone deviates not more than 10% from a constant value.

19. The process according to claim 2, wherein in said step (g) of regenerating a regeneration gas is chosen from the group of steam, air, oxygen and hydrogen, or suitable mixtures thereof.

20. The process according to claim 19, wherein said regeneration gas comprises at least two different components, said different components are dosed together.
